(19) United States
(12) Patent Application Publication
(10) Pub. No.: US 2010/0003026 A1
(43) Pub. Date: Jan. 7, 2010

(54) METHODS AND APPARATUS TO SUPPORT AND STABILIZE AN OBJECT

(76) Inventor: SHIRLEY KLEPPE, Scottsdale, AZ (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/495,950

(22) Filed: Jul. 1, 2009

Related U.S. Application Data
(60) Provisional application No. 61/077,422, filed on Jul. 1, 2008.

(51) Int. Cl. G03B 17/00

(52) U.S. Cl. 396/419

(57) ABSTRACT

Methods and apparatus for support and stabilization according to various aspects of the present invention include a cushioned surface mounted to a rigid base. The rigid base may comprise a connector suitably configured to attach the rigid base to a secondary supportive device or stand. The cushioned surface may be configured to receive and at least partially isolate a hand-held object from transmitted vibrations without a permanent or semi-permanent connection between the cushioned surface and the hand-held object.

### CROSS-REFERENCE TO RELATED APPLICATIONS

This application claims the benefit of U.S. Provisional Patent Application No. 61/077,422, filed on Jul. 1, 2008, and incorporates the disclosure of the application by reference.

### BACKGROUND OF INVENTION

The field of photography and videography often requires stabilizing the image capturing device from vibrations or movement during the capturing of still images or video. Various methods and devices to stabilize cameras and video recording devices have been developed including tripods, monopods, and various other support systems directed at providing a stable base for hands free operation. Many of these methods and/or devices require at least one of time, space, or suitable location in order to be used properly. Setting up a tripod for example takes time to set up which may result in a lost photographic opportunity. A tripod also takes time to break down which could result in a delay in getting to a new location. Additionally, locations such as a sitting row in a vehicle make using a device such as a tripod or monopod difficult.

Tripods and other similar mounting devices also require physical attachment of the device to the camera further adding to the time it takes to set up the camera for a shot and adding to the time necessary to break down after a shot. Although tripods, monopods, and the like provide stabilization to a camera, the use of such devices often results in the loss of mobility, thereby making the camera more static and cumbersome than may be desirable for some photographers.

### SUMMARY OF THE INVENTION

Methods and apparatus for support and stabilization according to various aspects of the present invention include a cushioned surface mounted to a rigid base. The rigid base may comprise a connector suitably configured to attach the rigid base to a secondary supportive device or stand. The cushioned surface may be configured to receive and at least partially isolate a hand-held object from transmitted vibrations without a permanent or semi-permanent connection between the cushioned surface and the hand-held object.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a stabilization device in accordance with an exemplary embodiment of the present invention;

FIG. 2 representatively illustrates a base with multiple connectors;

FIG. 3 representatively illustrates a cross-sectional view across line A-A of the base with multiple connectors shown in FIG. 2;

FIG. 4 representatively illustrates a base with an extendable connector;

FIG. 5 representatively illustrates a cross-sectional view across line B-B of the a base with an extendable connector as shown in FIG. 4;

FIG. 6 representatively illustrates a stabilizer with a resealable opening in accordance with an exemplary embodiment of the present invention;

FIG. 7 representatively illustrates a cross-sectional view of a stabilizer connected to a two-piece rigid base;

FIG. 8 illustrates a stabilization device attached to a monopod;

FIG. 9 illustrates a plurality of stabilization devices attached to the bottom of the legs of a tripod; and

FIG. 10, representatively illustrates a camera placed on the stabilization device in accordance with an exemplary embodiment of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described herein in terms of functional block components and various processing steps. Such functional blocks may be realized by any number of hardware components configured to perform the specified functions and achieve the various results. For example, the present invention may employ various process steps, apparatus, systems, etc. Further, the present invention may employ any number of conventional techniques for taking photographs, stabilizing cameras, and the like.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

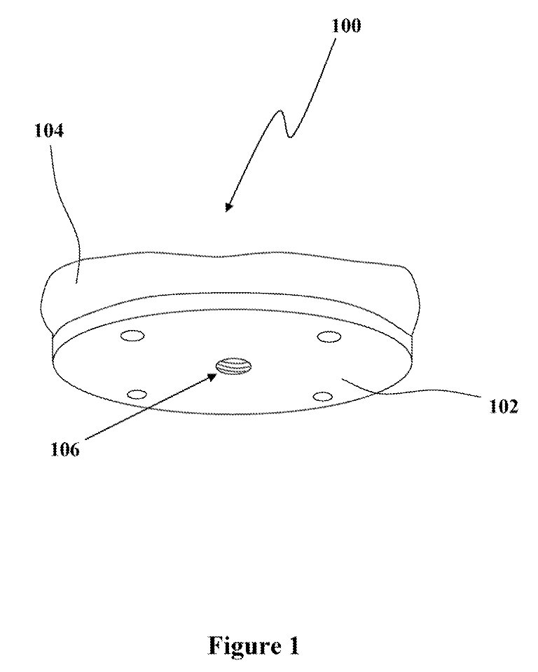

Methods and apparatus for support and stabilization according to various aspects of the present invention may operate in conjunction with any suitable mobile and/or stationary mounting device. Various representative implementations of the present invention may be applied to any system for capturing, targeting, or locating images. Certain representative implementations may include, for example, stabilization of cameras, video recorders, telescopic devices, and rifles. Referring now to FIG. 1, methods and apparatus for support and stabilization according to various aspects of the present invention may operate in conjunction with a stabilization device 100 comprising a rigid base 102 connected to a stabilizer 104. The rigid base 102 may be attached to the stabilizer 104 to allow an object, such as a camera, to be temporarily placed or rested on the stabilizer 104 without requiring mechanical attachment between the object and the stabilizer 104.

The rigid base 102 may comprise a surface capable of attachment to a separate mounting device and be suitably configured to support the weight of an object without significant deformation. The rigid base 102 may comprise any system suitably configured to support an object, such as a plate, a board a block, or a platform. The rigid base 102 may comprise any suitable material such as wood, metal, plastic, or composite. The rigid base 102 may also comprise multiple elements coupled together. For example, in one embodiment, the rigid base 102 may comprise two plates either bonded or mechanically coupled together. The rigid base 102 may also comprise stiffeners suitably adapted to reinforce the rigid base 102 against deformation when subjected to weight loading. For example, the rigid base 102 may comprise a thin metallic plate with carbon fiber reinforced doublers located on a surface of the rigid base 102 and suitably adapted to increase the resistance of the rigid base 102 to bending or other deformation.

The rigid base 102 may also be configured in any shape, size or thickness. For example, in one embodiment, the rigid base 102 may comprise a circular piece of machined aluminum approximately eight inches in diameter and approximately one-eighth of an inch thick to seven-eighths of an inch thick. In another embodiment, the rigid base 102 may comprise a rectangular shaped carbon reinforced composite material of between approximately one-sixteenth of an inch thick and two inches thick. The rigid base 102 may also be configured with extendable elements and/or attachments suitably adapted to modify the overall dimensions of the rigid base 102 to enable use with large or oversized objects. For example, in one embodiment, the rigid base 102 may comprise a circular plate of approximately six inches in diameter that is configured to receive a substantially rectangular attachment suitably adapted to modify the overall dimension of the rigid base 102 to conform to a camera affixed with a telephoto lens.

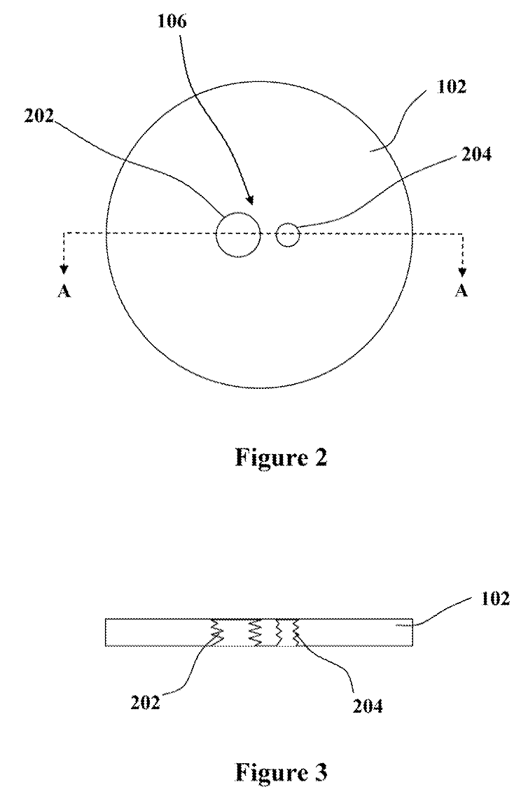

The rigid base 102 may further comprise at least one connector 106 suitably adapted to attach the stabilization device 100 to a stand such as a monopod or a tripod. The connector 106 may comprise any suitable system for removable connection such as a hole, a receptacle, a peg, a bolt, or a spring. For example, in one embodiment, the connector 106 comprises a threaded female insert set at least part way into a surface of the rigid base 102 and configured to receive a mating screw or bolt, such as that commonly used on tripods and monopods to affix a camera. In another embodiment, the connector 106 may comprise a coil spring embedded into a circular hole. In yet another embodiment, the connector 106 may comprise a nut embedded in a surface of the rigid base 102 that is configured to receive a mating screw. Referring now to FIGS. 2 and 3, in a fourth embodiment, the connector 106 may comprise multiple receptacles 202, 204 of varying diameter, wherein each receptacle 202, 204 passes through the rigid base 102 and is suitably configured for connection to a different sized mating connector.

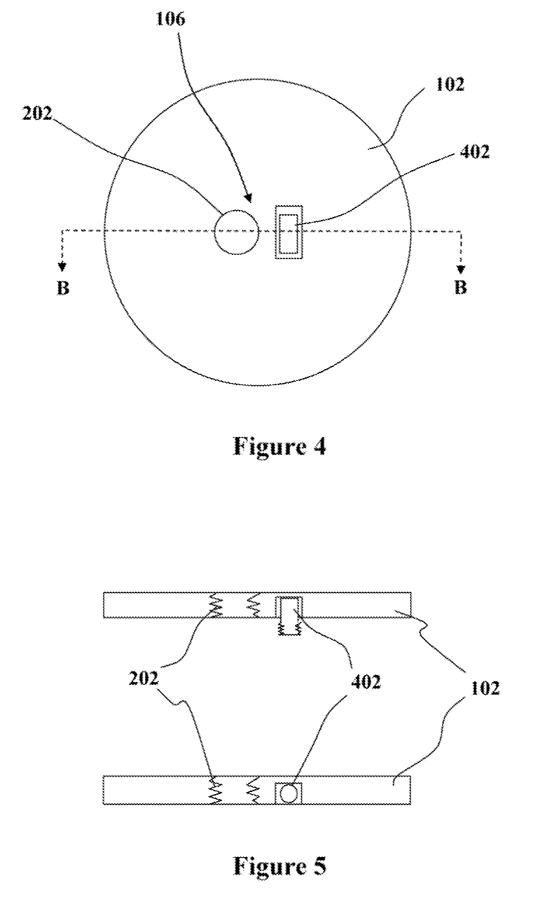

The connector 106 may also comprise a protrusion instead of, or in addition to, a threaded insert. For example, the protrusion may comprise a screw or an adapter configured to fit at least in part way into the connector 106 and have at least some portion protrude from the surface of the rigid base 102. The protrusion may then allow the stabilization device 100 to be connected, for example, to the feet of a tripod thereby reducing vibrations transferred to the tripod from the surface upon which the feet are placed. Referring now to FIGS. 4 and 5, in another embodiment, the protrusion 402 may also be housed substantially within the rigid base 102 and be configured to be pivotally extended outward from the rigid base 102 when necessary.

The stabilizer 104 connects to the rigid base 102 and provides a surface suitably adapted to receive the placement of an object such as a camera body, a telescopic lens, or the barrel of a rifle. The stabilizer 104 may comprise any suitable system for stabilizing an object such as a pouch, a cushion, a pillow, or a resealable pocket. The stabilizer 104 may comprise any suitably non-rigid material such as suede, denim, leather, cotton, microfiber, canvass, or similar fabric. The stabilizer 104 material may also be suitably adapted to resist puncturing or tearing such as might occur from contact with shrubbery, thorns, branches, rocks, or exposed nails. For example, the stabilizer 104 may comprise a composite exterior surface material with an outer face suitably adapted to prevent scratching a camera placed on the stabilizer 104 surface and an inner face material suitably adapted to resist an object puncturing all the way through the composite exterior surface material. The stabilizer 104 material may also be configured to withstand other environmental conditions such as water intrusion or be adapted to be anti-microbial, stain-resistant, quick drying, and/or the like.

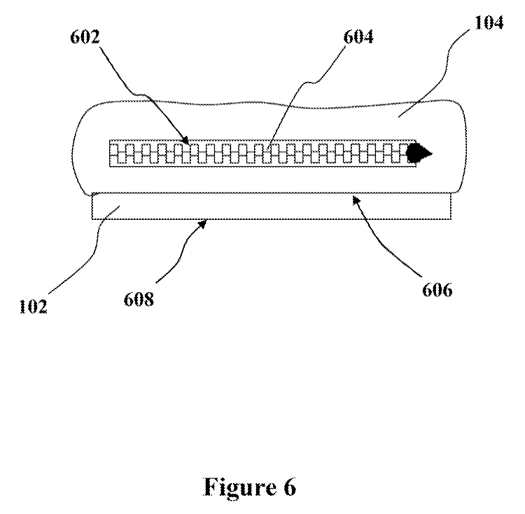

The stabilizer 104 may be configured to substantially conform to the shape of the rigid base 102 or it may be oversized or undersized in relation to the rigid base 102. The stabilizer 104 may further comprise a contoured section suitably adapted to conform to the shape of an object such as a telephoto lens. For example, referring to FIGS. 1, 6, and 7, the stabilizer 104 may be slightly larger in diameter or width than the rigid base 102. In another embodiment, the stabilizer 104 may be configured to wrap around a portion of a bottom side 608 of the rigid base 102. Alternatively, a portion of the stabilizer 104 may be configured to cover both a top side 606 and substantially all of the bottom side 608 of the rigid base 102 such that only the connector 106 is exposed to view.

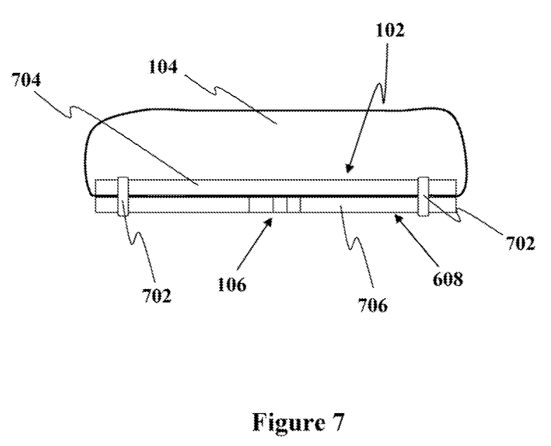

The stabilizer 104 may be connected to the rigid base 102 by any suitable method such as adhesively or with mechanical fasteners such as rivets, screws, or bolts. For example, referring now to FIG. 7, in one embodiment, the stabilizer 104 may be secured between a two-piece rigid base 102 comprising a top piece 704 and a bottom piece 706 of the rigid base 102 by a plurality of rivets 702. A suitable adhesive sealant may also be used between the top piece 704 and the bottom piece 706 of the rigid base 102 to reduce localized stresses at the location of the rivets 702 and/or prevent ingress or egress of materials between the stabilizer 104 and the rigid base 102.

The stabilizer 104 may also define an inner volume suitably configured to be filled with a stabilizing filler material. For example, referring to FIG. 4, the stabilizer 104 may be configured to form a cavity once secured to the rigid base 102. The stabilizer 104 may comprise an opening 602 which provides access to the cavity to allow the filler material to be added. The opening 602 may be configured with a sealing device 604, such as a zipper, so as to prevent the filler material from exiting the cavity.

The filler material may comprise any suitable material to provide at least a semi-conformable surface and/or a cushioning effect to the stabilizer 104. For example, materials such as rice, beans, visco-elastic polyurethane foam, expanded polystyrene beads, gel, or the like may be used for their ability to both support an applied weight and to shift within the cavity when subjected to a weight bearing load to substantially conform to the shape of the object placed on the stabilizer 104.

The filler material may also be disposed within a sealed pouch or bladder like device that is suitably configured to fit through the opening 602 and be securely placed within the inner volume of the stabilizer 104. For example, the sealed pouch may be filled with materials which are too small for personal handling such as ground-up recycled rubber, sawdust, ball bearings, or the like.

The opening 602 may further be configured with a sealing device 604 to allow the filler material to be removed, replaced, or refilled as needed. For example, during travel the cavity may be emptied allowing the stabilization device 100 to be packed more efficiently by reducing the overall size of the stabilization device 100. The opening 602 may comprise any suitable system that allows access to an interior volume of the stabilizer 104. The sealing device 604 may also be configured for closure by any suitable method such as a zipper, a flap with a hook and loop fastener, buttons, or a spring.

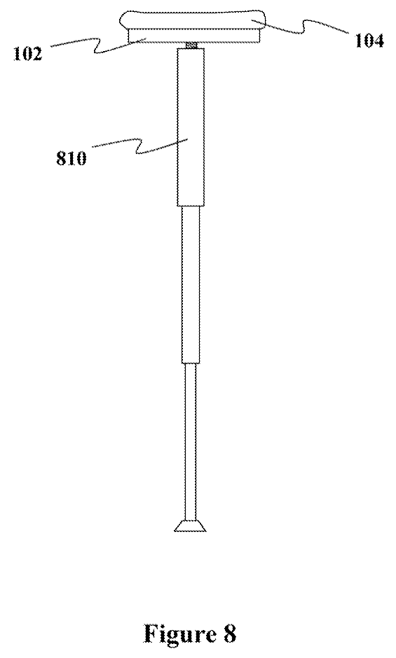

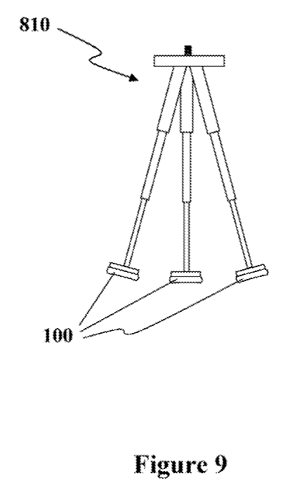

In operation a stabilizer 104 may be attached to a rigid base 102 to form a surface capable of supporting a hand-held object and at least partially isolating the hand-held object from vibrations applied to a surface of the rigid base 102. Referring now to FIG. 8, the rigid base 102 may be further configured with a connector 106 suitably configured to allow the rigid base 102 to be connected to a supporting device 810 such as a monopod. Referring FIG. 9, in an alternatively embodiment, the stabilization device 100 may be attached to the feet of a supporting device 810 to isolate the supporting device 810 from vibrations.

The stabilizer 104 may be configured to define an inner volume or cavity suitable adapted to receive a stabilizing material. The stabilizer 104 may further be configured with an opening 602 providing access to the inner volume and a sealing device 604 which may allow the opening 602 to be selectively accessed by an operator. The opening 602 may allow the stabilizing material to be added, removed, or adjusted as necessary and the sealing device 604 may prevent the stabilizing material from leaking and/or falling out of the inner volume.

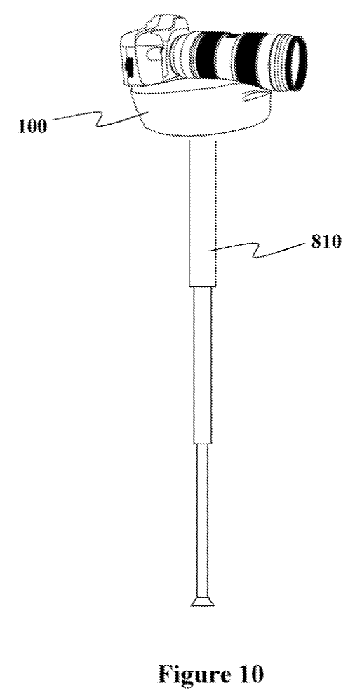

Referring now to FIG. 10, once the inner volume of the stabilizer 104 has been filled and the rigid base 102 attached to a suitable support structure, an operator may rest or otherwise place an object, such as a camera, on the stabilization device 100 to capture a desired image without the need to mechanically attach the camera to the stabilization device 100. The operator may then remove the camera after the image has been captured while leaving the stabilization device 100 connected to the support structure.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “coinprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A stabilization device for reducing transmission of vibrations between a support structure and a hand-held object, comprising:
a rigid base comprising a first side and a second side;
a connector coupled to the first side of the rigid base, wherein the connector is configured to selectively attach the rigid base to the support structure; and
a stabilizer comprising a cushioning surface coupled to the rigid base, wherein the stabilizer is configured to:
receive the hand-held object on the cushioning surface; and
reduce transmission of a vibration from the support structure to the object.

2. A stabilization device according to claim 1, wherein the stabilizer further comprises:
a refillable inner volume; and
a selectively accessible opening on a surface of the stabilizer, wherein the selectively accessible opening is configured to provide access to the inner volume.

3. A stabilization device according to claim 2, wherein the inner volume is configured to receive a cushioning material.

4. A stabilization device according to claim 3, wherein the cushioning material is disposed within a non-rigid pouch configured to fit in the inner volume.

5. A stabilization device according to claim 1, wherein the rigid base further comprises:
a first plate disposed along an inner surface of the stabilizer; and
a second plate coupled to the first plate along an exterior surface of the stabilizer.

6. A stabilization device according to claim 1, wherein the connector comprises a threaded receptacle extending at least partially into the first side of the rigid base.

7. A stabilization device according to claim 1, wherein the connector comprises a selectively extendable protrusion configured to be positioned between an extended position and a non-extended position relative to the first side of the rigid base.

8. A camera stabilization device for reducing transmission of a vibration between a camera support system and a camera, comprising:
a rigid plate comprising a first side and a second side;
a connector coupled to the first side of the rigid plate, wherein the connector is configured to selectively attach the rigid plate to the camera support system; and
a cushioned support member extending from the second side of the rigid plate, wherein the cushioned support member is configured to:
non-connectively receive the camera; and
reduce transmission of the vibration from the camera support system to the camera.

9. A camera stabilization device according to claim 8, wherein the cushioned support member comprises:
a refillable inner volume configured to selectively receive a filler material; and
a reseatable opening configured to provide access to the inner volume.

10. A camera stabilization device according to claim 9, wherein the rigid plate further comprises:
a first plate member disposed within the inner volume of the cushioned support member; and
a second plate member coupled to the first plate along an exterior surface of the cushioned support member.

11. A camera stabilization device according to claim 9, wherein the filler material is disposed within a sealed conformable pouch configured to fit within the refillable inner volume.

12. A camera stabilization device according to claim 8, wherein the connector comprises a threaded receptacle extending at least partially into the first side of the rigid plate.

13. A stabilization device according to claim 8, wherein the connector comprises a selectively extendable protrusion configured to be positioned between an extended position and a non-extended relative to a surface of the first side of the rigid plate.

14. A method of stabilizing an object engaging a support device comprising:
coupling a rigid plate to the support device;
attaching a stabilizer to a first side of the rigid plate, wherein the stabilizer comprises a cushioned surface adapted to inhibit transmission of vibrations from the support device to the object.

15. A method of stabilizing an object according to claim 14, wherein coupling the rigid plate to the support device comprises:
positioning a threaded female connector in a second side of the rigid plate; and
coupling the threaded female connector to a mating male connector on the support device.

16. A method of stabilizing an object according to claim 14, wherein the stabilizer further comprises a refillable inner volume.

17. A method of stabilizing an object according to claim 16, further comprising filling the refillable inner volume with a filler material.

18. A method of stabilizing an object according to claim 17, further comprising placing the filler material within a conformable pouch prior to placement within the inner volume, wherein the conformable pouch is configured to fit inside the refillable inner volume.

19. A method of stabilizing an object according to claim 17, wherein the stabilizer further comprises a resealable opening configured to provide access to the refillable inner volume.
